(19) United States
(12) Patent Application Publication
(10) Pub. No.: US 2004/0216122 A1
(43) Pub. Date: Oct. 28, 2004

(54) Method for routing data through multiple applications

(76) Inventors: Charles Gram, Santa Clara, CA (US); David J. Evans, Ottawa (CA)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/201,747

(22) Filed: Jul. 23, 2002

(51) Int. Cl. G06F 9/00; G06F 9/54; G06F 15/163

(52) U.S. Cl. 719/310

(57) ABSTRACT

Various embodiments of the invention provide a method, system, and apparatus for efficiently routing data through multiple applications. Generally, when data is received, the data type is identified or matched with a sequence of one or more applications. The corresponding data is then routed through the identified sequence of one or more applications according to the rules defined in the application stack.

### FIELD

Various embodiments of the invention pertain, generally, to data routing. More particularly, one embodiment of the invention relates a scheme to route data through multiple applications.

### BACKGROUND

As the sophistication of software applications increases, it is often desirable to have distinct applications perform specific operations on data and/or data stream. This may be the case where different applications cooperate in processing data or a data stream. For example, a first application may receive the data stream, if the data is encrypted, a second application may decrypt the received data stream, and a third application may process the decrypted data stream.

However, a mechanism is necessary to route data streams from one application to the next. That is, a way of managing the routing of a data through multiple applications is needed.

The traditional approach uses network load balancers to re-direct a data stream to an application. The load balancer approach works well with a single application. However, scaling this approach for routing a data stream to multiple applications is generally inefficient since it typically requires configuring one or more filters (or rules) on a network switch. As the number of filters increase, network performance decreases. The filters are typically evaluated in sequence. For example, a filter that redirects or routes data to Application A will be evaluated first. When the data returns from Application A, then all filters will be evaluated again to determine if the data should be redirected to Application B. This would typically involve re-evaluating Application A's filter, bypassing Application A's filter, and evaluating Application B's filter. As the number of applications increase, this becomes a computationally intensive and complex process to execute.

### BRIEF DESCRIPTION OF THE DRAWINGS

FIG. 1 is a block diagram illustrating the general methodology for implementing data routing through multiple applications according to one embodiment of an aspect of the invention.

FIG. 2 is a block diagram illustrating a system for routing a data stream through one or more applications.

FIG. 3 is a table illustrating an example how the relationships between data types and application stacks may be specified.

FIG. 4 illustrates exemplary configurations of various routing applications stacks that may be specified according to various aspects of the invention.

FIG. 5 is a block diagram illustrating the path of the data stream for Application Stack 1 in FIG. 4.

FIG. 6 is a block diagram illustrating the path of the data stream for Application Stack 4 in FIG. 4.

FIG. 7 is a block diagram illustrating the path of the data stream for Application Stack 5 in FIG. 4.

FIG. 8 is a block diagram illustrating the path of the data stream for Application Stack 6 in FIG. 4.

FIG. 9 is a block diagram illustrating the path of the data stream for Application Stack 7 in FIG. 4.

FIG. 10 is a flow diagram illustrating a method for creating an application stack and validation of said application stack.

### DETAILED DESCRIPTION

In the following detailed description of various embodiments of the invention, numerous specific details are set forth in order to provide a thorough understanding of various aspects of one or more embodiments of the invention. However, one or more embodiments of the invention may be practiced without these specific details. In other instances, well known methods, procedures, and/or components have not been described in detail so as not to unnecessarily obscure aspects of embodiments of the invention.

In the following description, certain terminology is used to describe certain features of one or more embodiments of the invention. For instance a “data stream” may include one or more data frames or packets. A “frame” and/or “packet” includes any block or arrangement of data or information including a series of information bits. The term “information” or “data” is defined as voice, video, text, address, and/or control. Data streams or packets may be sent over packet-switched networks including Asynchronous Transfer Mode (ATM), frame relay, Internet Protocol (IP) networks. These packets may be routed over communication paths, which are formed using information-carrying mediums such as electrical wire, optical fiber, cable, bus, air in combination with wireless signaling technology or any combination thereof. The term “application” includes any software program, one or more processor-executable instructions, embedded program, hardware executable sequence, and/or a combination thereof. The terms “stack” or “cluster” (e.g., application stack or cluster) includes a list or group of one or more applications. One aspect of an embodiment of the invention provides a method, system, and apparatus for efficiently routing data through multiple applications. Generally, when a data stream is received, the stream type or data type is identified with a sequence of one or more applications; the data is then routed through the identified sequence of one or more applications.

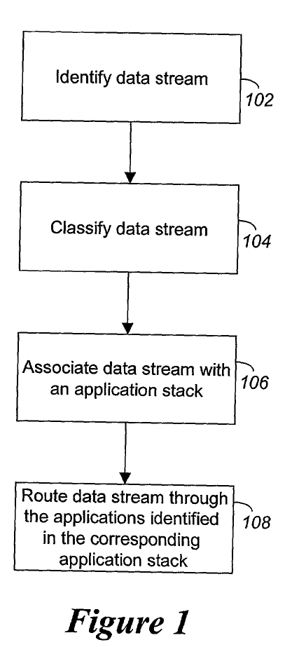

FIG. 1 is a block diagram illustrating the general methodology for implementing one embodiment of an aspect of the invention. A data is first identified 102. In one implementation the data may be part of a data stream or packet for instance. The receiving system recognizes that a data stream is being received. The data, data stream, and/or data packet, is then classified according to one or more pre-determined or dynamically determined factors 104. In one implementation, a received packet or frame is classified based on information found in its header (e.g., packet type, content type, etc.). In another implementation, a data stream or channel may be classified initially and all subsequent data received over said channel or data stream receives the same classification. In another embodiment, classification is performed on a packet-by-packet or frame-by-frame basis.

Once a data stream and/or data packet is classified, the data stream or data packet may be associated with a particular application stack or cluster 106. An application stack or cluster may include a list of one or more applications that specifies the applications to which the data stream should be sent. The application stack may also disclose the sequence or order in which the data stream should pass from one application to the next.

Once a data stream or data packet has been associated with a particular application stack (e.g., a group of one or more applications) the data stream or data packet is routed through the applications specified in that application stack 108. That is, if for a given data stream type there has been a particular application stack specified, then the data stream is sent to the applications specified in that particular application stack. In one implementation of the invention, if no application stack has been specified for a given data stream type, then that data stream type is sent to the applications specified in a default application stack. In another embodiment of the invention, if no application stack has been specified for a given data stream type, then that data stream type is handled normally (i.e., without the use of an applications stack). Once the data stream has been routed through the applications specified in the application stack, the association with the application stack may be removed.

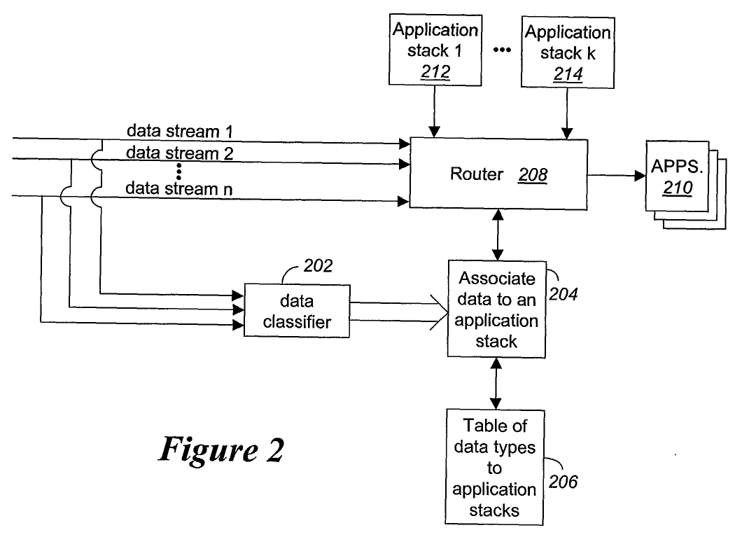

FIG. 2 is a block diagram illustrating a system for routing a data stream through one or more applications. As a data stream is received (e.g., data streams 1, 2, or n, where n is an integer) a data classifier 202 classifies the data stream or data packets according to some criteria. For example, the data header, data channel, sender, data type, etc., or a combination of these or other factors may be employed to classify or identify a particular data stream or data packet. The classification or identification of the data stream or data packet is then used by an associator 204 to associate the data packet with a particular application stack. That is, if an application stack has been specified for the particular data stream type or packet type, then said application stack may be associated with said data stream or data packet. In one embodiment of the invention, a table 206 defining the relationship between data types and application stacks may be coupled to the associator 204 to facilitate the association process.

An application router 208 receives a data stream (e.g., data streams 1, 2, n, where n is a positive integer) and is communicatively coupled to the associator 204 to determine how to process the received data stream. If the application router 208 ascertains that a received data stream has been associated with an application stack, then the application router 208 routes the data stream to the application(s) 210 specified in said application stack (e.g., 212, 214, etc.). In one implementation, the application router 208 may be a processor and/or switch to send the data stream from one application to the next according to the specified applications and rules in the corresponding application stack (e.g., 212, 214, etc.). The rules specified in the application stack may specify, among other things, the sequence in which data is to be routed through the one or more specified applications, branching paths, and embedded references to other applications stacks.

It should be clearly understood that while the block diagram of FIG. 2 shows an application router 208 to route data between applications, one or more aspects of the invention may be practiced in other systems and/or devices, including other routers such as data routers, without departing from the invention.

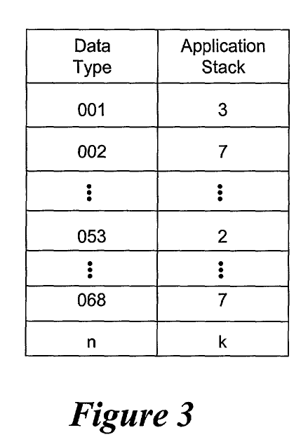

FIG. 3 is a table illustrating an example how the relationships between data types and application stacks may be specified. Data types may be denoted by numeric, alphanumeric, acronyms, size, letters, or any other identifier. Similarly, application stacks may be identified by a number, name, address, or any other means. An application stack may be associated with one or more data types.

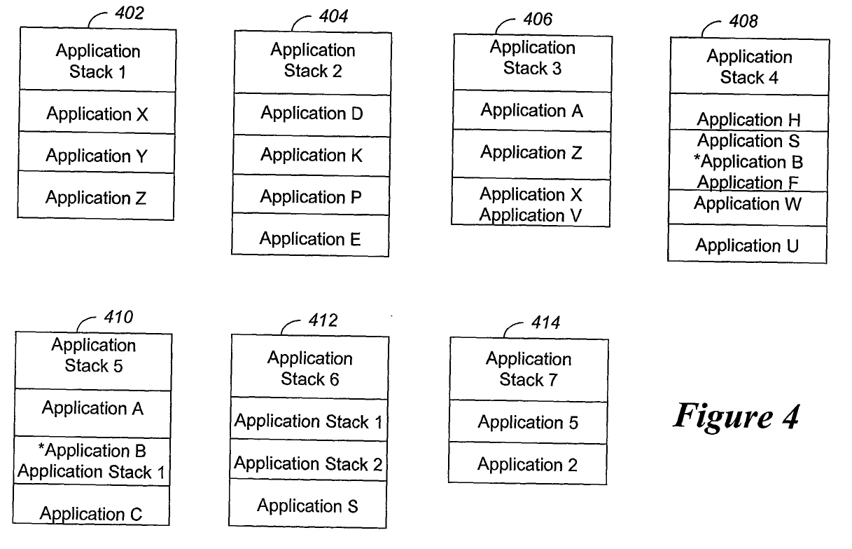

FIG. 4 illustrates the exemplary configuration of various application stacks that may be specified according to various aspects of the invention. The application stacks shown are intended to be illustrative of the ways in which they may be configured and are not the only ways in which an application stack may be specified. The applications (e.g., APP. X, APP. A, etc.) shown in the applications stacks (e.g., application stacks 1-7), are intended to represent any application that a user may wish to employ. Different applications are identified by the different application names (e.g., APP. A, APP. B, etc.). However, it must be understood that an application may also be identified in an application stack in a number of different ways including by a reference pointer, a number, an address, and/or some other identifier.

Application Stack 1 402 shows that whatever data type, data stream type, and/or packet type is associated with said stack 402, said data should be sequentially routed to App. X, then App. Y, and finally App. Z. The routed data or information may or may not be modified by one or more of the applications (e.g., APP. X, APP. Y, APP. Z) as it passes through the applications specified in the stack.

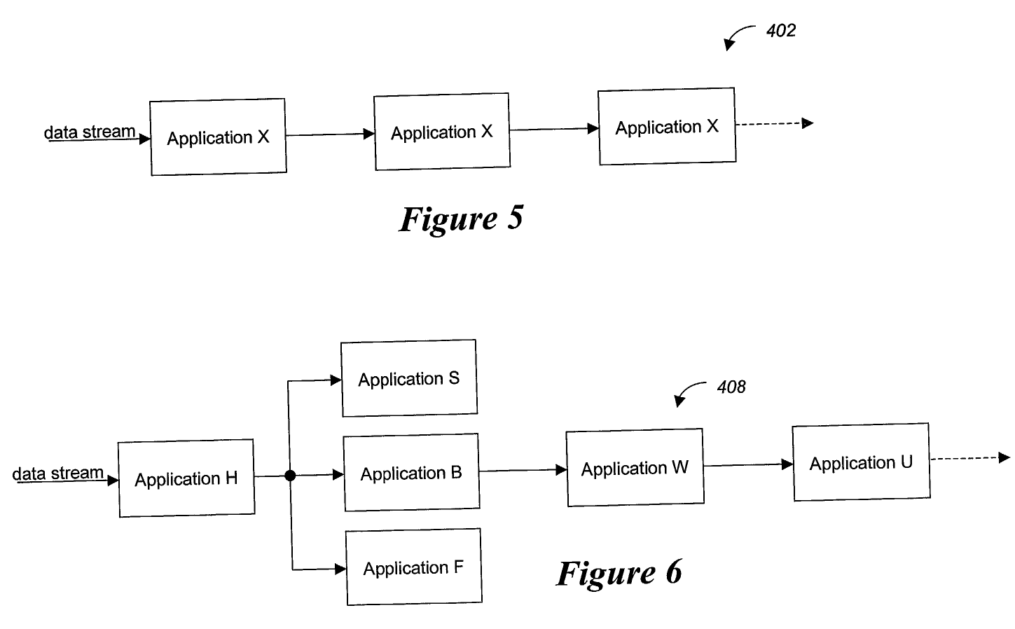

According to one aspect of the invention, the order in which applications appear in an application stack may also indicate sequence in which the data, data stream, and/or data packet should be routed from one application to the next. For example, the path of a data stream or packet associated with Application Stack 1 402 is illustrated in FIG. 5. The data stream or packet would pass sequentially from App. X to App. Y to App. Z.

As in Application Stack 1 402, Application Stack 2 404 illustrates how data may be routed through various applications (i.e., APP. D, APP. K, APP. P, and APP. E).

Application Stack 3 406 illustrates a different way in which a routing path may be specified. The data may be routed to APP. A, then APP. Z, and then to both APP. X and APP. V. This illustrates that the data may be routed serially to APP. A and then APP. Z, and then in parallel to APP. S and APP. V. This may be useful in defining a “tree” structure that the data should traverse.

Application Stack 4 408 illustrates yet another aspect of the invention where embedded levels of application stacks may be supported. Data or a data stream would first be routed to APP. H. Then the data would be routed, in parallel to APP. S, APP. B, and APP. F. In this example, APP. B in Application Stack 4 408 may be tagged so that the data that passes through APP. B is then routed to APP. W and subsequently to APP. U. The path of data routed according to Application Stack 4 408 is also illustrated in FIG. 6.

Application Stack 5 410 illustrates yet another aspect of the invention where embedded levels of application stacks may be supported. Data or a data stream would first be routed to APP. A. Then the data would be routed or directed, in parallel to both APP. B and Application Stack 1 402. To permit further processing of the data, one of the paths may be tagged so that data in that path may be routed to subsequent applications in the stack. For instance, APP. B may be tagged so that once the data has been processed by APP. B it is routed to APP. C.

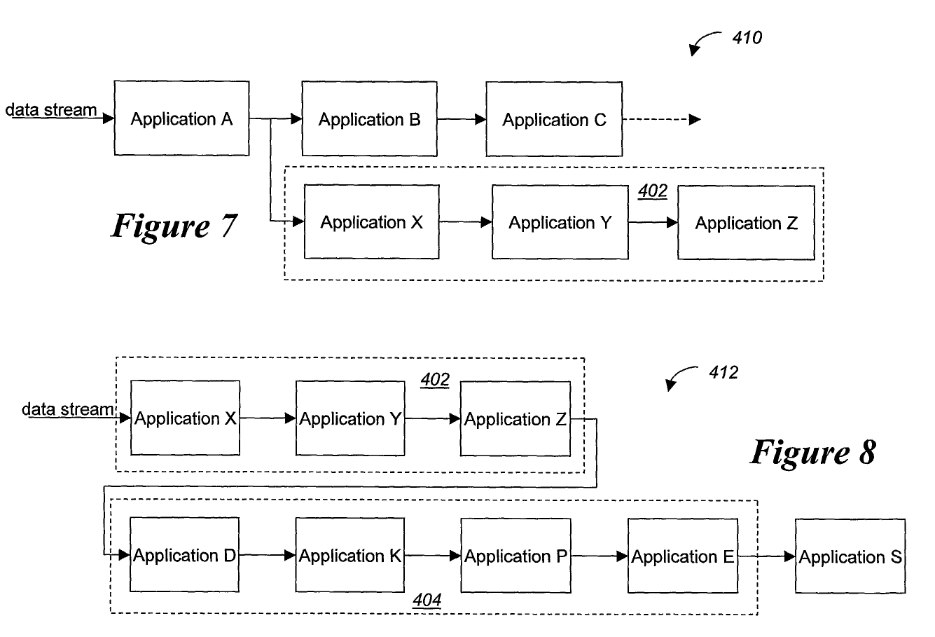

In the embodiment of the invention shown in Application Stack 5 410, an embedded call to another application stack (Application Stack 1 402) is shown. As illustrated in the block diagram of FIG. 7, the data or data stream is directed from APP. A to both APP. B and Application Stack 1 402, in parallel. Specifically, the data passes to APP. X, and subsequently to APP. Y and APP. Z, in Application Stack 1 402. In setting up such embedded redirections from one application stack to another, care should be taken to avoid infinite embedded calls to an application. This may occur when a loop is established which continually calls a particular application. In one implementation of the invention, once a particular application stack is defined a validation process is employed to check and warn of infinite or undefined embedded loops.

Application Stack 6 412 illustrates yet another aspect of the invention where multiple serial redirections to other application stacks made. FIG. 8 is a block diagram illustrating the path of the data associated with Application Stack 6 412. The data or data stream is routed to Application Stack 1, passing through APP. X, APP. Y, and then APP. Z, then to Application Stack 2, passing through APP. D, APP. K, APP. P, and APP. E, and then is directed to APP. S.

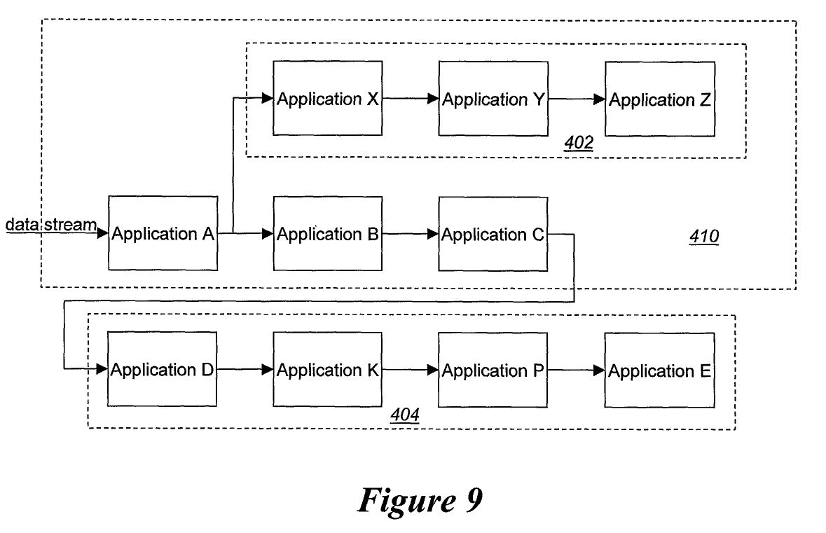

Application Stack 7 414 illustrates how multiple embedded paths may be defined. FIG. 9 is a block diagram illustrating the data routing path of Application Stack 7 414. The data or data stream is routed to APP. A and then directed in parallel to APP. B and the applications in Application Stack 1 402. Once the data stream passes APP. C. it is directed to the applications in Application Stack 2 404, APP. D, APP. K, APP. P, and lastly APP. E.

The routing of a data stream or data packet from one application to another may be accomplished in a number of ways. In one embodiment of the invention a central routing scheme may be employed. In a central routing system the data or data stream flows from a central application router (e.g., router 208 in FIG. 2) to each application. After a data stream has passed through an application (e.g., APP. X Stack 1 402 in FIG. 2), the central application router then sends it to the next application in the application stack (e.g., APP. Y Stack 1 402 in FIG. 2), if any. That is, the redirection of the data stream from one application to the next is controlled by a central routing device or agent.

In another embodiment of the invention a distributed routing scheme may be employed. In a distributed routing system, the data or data stream routing is performed by each application without any other intervening process or agent. That is, once as a data stream exits a particular application (e.g., APP. X Stack 1 402 in FIG. 2), that particular application directs the data stream onto the next application (e.g., APP. Y Stack 1 402 in FIG. 2) in the application stack, if any. The distributed routing scheme relies on each application to forward the data stream to the next application in the application stack, if any. Thus, once an application processes a data stream, it checks the corresponding application stack for that data stream and directs the stream to the next application in the stack, if any.

According to one implementation of the invention, the application stack for a given data stream or data packet may be appended to the data stream or packet. In a central routing scheme, a routing agent may merely access the appended application stack to direct a data stream to its next application, if any. In a distributed routing scheme, an application may direct a data stream or packet by reading the appended application stack.

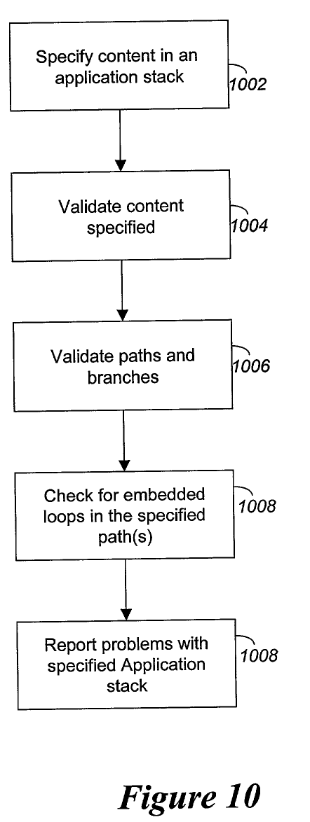

One aspect of the invention provides a validation scheme to validate the content of application stacks. FIG. 10 is a flow diagram illustrating one such method of creating an application stack and validation of said application stack. First, the content of the application stack is specified 1002. In specifying an application stack, the content may include one or more application names, application pointers, application identifier, or combination thereof. The content may also include one or more references to other application stacks. Additionally, the application stack may include a tag or marker to denote which application's output is to be forwarded in those instances where multiple paths may have been defined (e.g., APP. S, APP. B, and APP. F in Application Stack 4 408 in FIG. 4).

Once the content of a newly created application stack is specified, it is then validated. That is, the existence of the listed applications, reference pointers, and/or other listed application stacks in the newly created application stack should be verified. If one or more of the listed items in the newly created application stack are invalid (e.g., they do not exist, etc.), then the user is informed of this condition.

The data or data stream paths specified in the newly created application stack are then validated 1006. The validity of the paths may be checked for continuity and certainty. For instance, in Application Stack 4 408 in FIG. 4, the validation process would ascertain that a definite and certain path exists for the data stream from fork to APP. S, APP. B, and APP. F to the subsequent applications in the stack. In this example, APP. B has been tagged or marked so that the data stream passing through APP. B is directed to APP. W and then APP. U. Thus, the validation process may check for valid paths and branch configurations in a newly created application stack.

Next, the application stack is checked for invalid embedded loops 1008. For instance, the application stack may be checked for infinitely embedded loops that may occur, for instance, when a first application stack directs the data stream to a second application stack (e.g., calls the second application stack) that in turn redirects the data stream back to the first (e.g., calls the first application stack). That is, since each redirection to a new application stack directs the data stream flow to the application at the beginning of the new application stack, this causes an infinitely embedded loop where a first application stack references a second application stack which, in turn, references the first application stack. The validation process can check for such infinitely embedded redirections of the data stream and notify the user.

Lastly, any problems discovered are reported to the user 1010.

In one implementation of the invention, the validation process may be implemented in a software application or in processor-readable instructions.

The different aspects of the invention described herein may be implemented in a number of different ways and in a number of different types of systems. Generally, one or more aspects of the invention permit a user to exert control over the sequences of applications that different types of data streams traverse. Typically, a user may want to create an application stack or cluster for applications that have complementary functionality.

In one embodiment of the invention, one or more aspects of the invention may be implemented in a security system where an application stack or cluster may include security applications that perform such functions as firewalls, encryption, decryption, intrusion detection, data monitoring, archiving, etc.

In another embodiment of the invention, one or more aspects of the invention may also be implemented in a network switch where an application stack or cluster may include various encryption/decryption, routing, archiving, and/or monitoring applications, services, and/or functions.

In another embodiment of the invention, one or more aspects of the invention may also be implemented in web servers, email servers, and/or file transfer servers where an application stack or cluster may include various web, email, and/or file transfer applications, services, and/or functions.

In one embodiment of the invention, the applications specified in the application stack or cluster reside in the same server or local processing resources. This may be desirable where, for instance, the structure or form of data streams or data packets are modified by one or more of the specified applications. For example, an application may decrypt a data packet, remove its header, or change the packet in some other way which would require reformatting it for transmission to one or more applications in the application stack. That is, in routing data packets or streams between applications specified in an application stack, performance considerations may make it more desirable to avoid the routing of the data packets or data streams over a packet switch channel or network.

While certain exemplary embodiments of the invention have been described and shown in the accompanying drawings, it is to be understood that such embodiments are merely illustrative of and not restrictive on the broad aspects of various embodiments of the invention, and that these embodiments of the invention not be limited to the specific constructions and arrangements shown and described, since various other modifications are possible. For example, wherever the term “data stream” is employed it should be clearly understood that a data packet or any other forms of data configurations may be interchangeably employed without departing from the invention. Additionally, it is possible to implement the embodiments of the invention or some of their features in hardware, programmable devices, firmware, software or a combination thereof.

What is claimed is:

1. A method comprising:
associating data with an application cluster; and
routing the data according to rules specified in the application cluster.

2. The method of claim 1 further comprising:
classifying the data, wherein classifying the data includes
identifying a data type from information found in the data, and
determining if the data type corresponds to a pre-specified application cluster.

3. The method of claim 1 wherein the data is associated with an application cluster only if a corresponding application cluster is specified.

4. The method of claim 1 further comprising:
specifying an application cluster for one or more data types.

5. The method of claim 4 wherein an application cluster includes one or more applications.

6. The method of claim 4 wherein an application cluster includes one or more other applications clusters.

7. The method of claim 1 wherein the rules specified by the application cluster provide a sequence in which the data should be routed through one or more applications in the application cluster.

8. The method of claim 1 wherein routing of the data is accomplished according to a centralized routing scheme.

9. The method of claim 1 wherein routing of the data is accomplished according to a distributed routing scheme.

10. A machine-readable medium having one or more instructions for routing data through one or more applications, which when executed by a processor, causes the processor to perform operations comprising:
associating data with an application cluster; and
routing the data according to rules specified in the application cluster.

11. The machine-readable medium of claim 10 further comprising:
classifying the data, wherein classifying data includes
identifying a data type from information found in the data, and
determining if the data type corresponds to a pre-specified application cluster.

12. The machine-readable medium of claim 10 wherein the data is associated with an application cluster only if a corresponding application cluster is specified.

13. The machine-readable medium of claim 10 having one or more instructions for routing data through one or more applications, which when executed by a processor, causes the processor to further perform operations comprising:
specifying an application cluster for one or more data types.

14. The machine-readable medium of claim 10 wherein an application cluster includes one or more applications.

15. The machine-readable medium of claim 10 wherein the rules specified by the application cluster provide a sequence in which the data should be routed through one or more applications in the application cluster.

16. A device comprising:
an associator to associate data with an application cluster; and
a router coupled to the associator, the router to route the data according to rules specified in the application cluster.

17. The device of claim 16 further comprising:
a classifier coupled to the associator to classify the data according to a type, wherein the classifier
identifies the data type from information found in the data, and
determines if the data type corresponds to a pre-specified application cluster.

18. The device of claim 16 wherein the associator associates the data with an application cluster only if a corresponding application cluster is specified.

19. The device of claim 16 wherein an application cluster includes one or more applications.

20. The device of claim 16 wherein the rules specified by the application cluster provide a sequence in which the data should be routed through one or more applications in the application cluster.
